(19) United States
(12) Patent Application Publication
(10) Pub. No.: US 2015/0302711 A1
(43) Pub. Date: Oct. 22, 2015

(54) EAS DEVICE HAVING INTERCHANGEABLE CONTOURED BASE

(71) Applicant: Xiao Hui Yang, Saratoga, CA (US)

(72) Inventor: Xiao Hui Yang, Saratoga, CA (US)

(21) Appl. No.: 14/704,948

(22) Filed: May 5, 2015

Related U.S. Application Data
(63) Continuation-in-part of application No. 14/201,842, filed on Mar. 8, 2014.
(60) Provisional application No. 61/775,006, filed on Mar. 8, 2013.

(51) Int. Cl. G08B 13/24

(52) U.S. Cl. CPC G08B 13/2434

(57) ABSTRACT

An electronic article surveillance device attaches to an object to be protected. The EAS device has a base, or mount, and a housing which contains EAS electronics. The housing and base are separate but have elements which act together to attach the housing to the base. The base attaches to the object and has a surface contoured to fit the contour of the object to be protected. The base, or mount, may be attached to the object by an adhesive element. Multiple interchangeable bases having differently countered surfaces allow a housing to be attached to different objects having different contours.

### CROSS REFERENCE TO RELATED APPLICATIONS

This application is a continuation-in-part application of U.S. application Ser. No. 14/201,842, filed on Mar. 8, 2014. U.S. application Ser. No. 14/201,842 claims priority to U.S. Provisional Application 61/775,006 filed on Mar. 8, 2013. The entirety of U.S. application Ser. No. 14/201,842 and U.S. Provisional Application 61/775,006 including both the figures and specifications are incorporated herein by reference.

### FIELD AND BACKGROUND OF INVENTION

The present application is generally related to an electronic article surveillance (EAS) device, and more specifically, an EAS device that attaches to an object to be protected and maintains communication with an RFID label previously associated with the object. Also, the device of the present application may be used with various systems, including for example, an EAS system utilizing devices and deactivators featuring wireless communication for deactivation and alarming and featuring dynamic time based pass code modification and other tamper resistant features, and/or an EAS system using passive element technology, inventory systems, the Internet, or systems combining features of the aforementioned systems. The EAS device of the present invention may act as an RFID relay between a weaker RFID label and a broader system.

RFID labels, sometimes also called RFID tags, are known in the art. They are small, but they have transmitting and memory capabilities. Some have read-only memory but others have rewritable memories which allow the information in the RFID label to be updated. The amount of memory varies and influences the size and cost of the integrated circuit portion of an RFID label. Between 128 bits and 512 bits of total memory can be provided economically. For example RFID labels available from Texas Instruments of Dallas, Tex., under the designation “Tag-it” provides 256 bits of user programmable memory in addition to 128 bits of memory reserved for items such as the unique tag serial number, version and manufacturing information, and the like. Similarly, RFID labels available from Philips Semiconductors of Eindhoven, Netherlands, under the designation “I-Code” provides 384 bits of user memory along with an additional 128 bits reserved for the aforementioned types of information. Another line of RFID labels is the N×P Semiconductor Mifare line. 13.56 MHz is a common operating frequency for communications by RFID labels.

### RELEVANT ART

U.S. Pat. No. 8,260,948 by Chand, et al. is for an enhanced controller utilizing RFID technology. In Chand, a radio frequency identification (RFID) component receives a data stream from at least one RFID tag. A controller can integrate and/or embed at least one of the following, 1) middleware that filters the data stream associated with the RFID component, 2) RFID software that provides RFID component software functionality, and 3) a smart component that connects to the RFID component.

U.S. Pat. No. 8,284,045 by Twitchell, Jr. is for a container tracking system. Shipping containers are networked for transferring data between the shipping containers. The shipping containers include sensors for detecting conditions associated with the shipping containers. The conditions sensed by any shipping container whether transported by rail or ship is transmitted from an ad hoc network, via a gateway configured for satellite or cellular communications for example, to a container-tracking application server or equivalent computer system. The computer system is remotely located to the shipping container for central compilation, analysis, and/or display of data regarding the shipping containers.

U.S. Pat. No. 6,724,308 by Nicholson is for an RFID tracking method and system for using multi-functional RFID tag assemblies, passive repeater systems and modular antenna systems. One embodiment comprises a method for communicating with an RFID tag by providing a passive loop modular antenna system, moving the RFID tag through a field related to the modular antenna system and transmitting energy through the antenna to communicate with the RFID tag. In a further embodiment, the RFID tag includes a passive loop in proximity with the RFID tag to improve the signals received and transmitted by the tag. In another embodiment, the RFID tag is removeably attached to a product container having a product therein and adapted to be removed from the container and re-attached to the product or a second container.

### SUMMARY OF EMBODIMENTS OF THE INVENTION

The present invention is for an electronic article surveillance device having an electronics housing portion and a mount portion. The mount portion secures directly to an object such as a box while the electronics housing portion is maintained on the object by the mount portion. Electronics within the housing portion maintain communication with an RFID label previously associated with the object. For example, an RFID label may be placed within the box of a consumer good at the time that the consumer good is produced and packaged. An EAS device of the present invention attaches externally to the box and maintains communication with the RFID label within the box and provides additional security and other features. The EAS device may act as an RFID relay to facilitate monitoring of RFID labels by a broader RFID system monitoring RFID labels for EAS, inventory, and other purposes.

The mount portion of the EAS device may have an adhesive element on it so that it will adhere to an object when it is placed on the object. Other embodiments may use an encircling element to maintain the mount portion on the object. These encircling elements may themselves employ an adhesive element or simply pass around the object in such a manner as to maintain the mount portion on the object.

The mount portion may maintain the housing portion in position by different means depending on the embodiment. In some embodiments of the EAS device, the mount may have a first part of a connecting mechanism and the housing a second part of a connecting mechanism. The two parts of the connecting mechanism are complimentary and allow the housing to be connected to the mount. In some embodiments of the EAS device, this connection is releasable. In other embodiments of the EAS device, the mount may include a shell capable of enclosing around the housing before the mount is applied to the object. In some of these embodiments the shell may only partially enclose the housing, while the object completes the enclosure of the housing when the mount is applied to the object. In still other embodiments of the EAS device, an encircling element encircles the housing and maintains the housing in position on the mount.

In some embodiments of the EAS device employing a mount that couples with the housing, the mount may have a contoured surface. This surface is contoured to fit the contoured surface of an object to be protected. The contoured surface on the mount matching the contour of the object provides better attachment between the mount and the object. Different mounts having different contoured surfaces can be used to match the contour of different objects. As an example many objects are cylindrical with different radii for the cylindrical surfaces. Mounts with contoured surfaces having cylindrical sections with different radii can be used to match different objects.

In embodiments of the EAS device where the housing portion and the base portion each have complimentary connecting components which allow them to be assembled to each other, the connecting components may take several forms. In one embodiment, components on the housing and mount may form a hinge together while other complimentary components interlock when the housing and mount are rotated against each other about the hinge. In other embodiments, connecting components on the housing or mount may insert into apertures on the other. A retention mechanism may then engage the inserted component. In some embodiments employing connecting components that insert into complimentary apertures, a subsequent sliding motion may complete the coupling of the housing and mount, while a spring biased pin prevents separation. In many of these embodiments, a magnetically attractable blocking element is utilized to prevent the separation of the housing and mount. Application of a magnet moves this blocking element from the blocking position, allowing removal of the housing from the mount.

The electronic housing portion of the EAS device may have several electronic components within it. Among the several possible electronic components are: a microprocessor, a circuit board, a battery, a motion detector, an audible alarm producing element, radio frequency communication circuitry, an optical communication port, a light emitting diode, switches, and a passive EAS element such as an EAS core and coil element. The battery can be rechargeable or non-chargeable. Other types of onboard power supplies may also be used. The microprocessor monitors the switches to determine the physical state of the EAS device with respect to installation or tampering.

Switches may be positioned to detect when the electronics housing and mount are assembled to the object, to detect when a latching element has moved, or to detect when a blocking element has moved into a blocking position, and a switch may be provided to power up the device when it is first put into service. In some embodiments, the electronic housing portion of the EAS device has a switch protruding from its bottom surface. For embodiments of the EAS device where the mount partially encloses the electronic housing and attaches to an object, an installation switch indicates that the EAS device is assembled to an object. For embodiments where the housing attaches to the mount with connecting elements, an aperture in the mount aligned with the installation switch allows the switch to protrude through the mount. When the installation switch changes state, this indicates that the EAS device is attached to an object and ready to be armed.

Some embodiments of the EAS device may have a switch in position to change state when a latching mechanism moves. The microprocessor or circuit board can detect switch status to determine when a latch is engaged between the housing and the mount. Other embodiments may employ a switch to determine when a blocking mechanism has moved into or out of a blocking position. Whether a switch is used to monitor a latching mechanism, or a blocking mechanism, or both, is determined by the physical design and characteristics of the EAS device. If these switches are used, they can provide additional signals or steps for the arming process.

Once the EAS device is fully applied to an object to be protected, it can be armed by the microprocessor based on the switch states or a final step for arming may include communication from an external device of the larger EAS system. This communication may be wireless or through direct contact with the external device. If the communication is wireless, depending on the particular EAS device and system, the communication may be radio frequency communication or optical communication. The system with which the device wirelessly communicates may be an EAS system, an inventory system, the Internet, or some combination of those systems.

It is very common for RFID labels to be placed within the packaging of products at the time the product is created and packaged. These RFID labels have greater capabilities than passive EAS labels which only generate a reactive signal when an interrogation is present. These RFID label can store information about the product and transmit it over a radio frequency when interrogated by an external RFID signal generated by an external electronic device. The identifying information of the label assists with inventory and other functions. The RFID label may have its own power supply or it may rely on energy converted from the interrogation signal to transmit back its information.

The embodiments of the EAS device of the present invention are themselves capable of generating an interrogation signal and interacting with RFID labels. For example, when the EAS device is attached to a box containing an RFID label, the EAS device is in close enough proximity with an RFID label, and the microprocessor in the EAS device operates the radio frequency circuitry to interrogate the RFID label. The EAS device has its own power supply and can generate a more powerful signal to retransmit the information from the RFID label further than the RFID label can itself. This added range allows communication with the greater EAS or inventory system without requiring the box, in this example, being close to an interrogating unit.

Some embodiments of the EAS device will incorporate the initial communication with an RFID label as part of the arming process. Once an EAS device is attached to an object such as a box, it generates an interrogation signal to detect if a RFID label is present in the box and interrogates the RFID label for its information. Once a connection is established with the RFID label, some embodiments of the EAS device will arm automatically, while others may send out a signal communicating that a connection has been established with the RFID label. This signal may be a radio frequency signal, an optical signal, or an audible signal. The radio frequency signal may trigger an automated arming signal from the EAS system, while an optical or audible signal may trigger a similar automated arming or inform an operator that the EAS device is ready to be armed. In the latter case, an operator would use an external device to communicate with the EAS device and arm it.

Once the EAS device is attached to an object it can interact with the larger EAS or inventory system until disarmed and removed from the object, or box. While armed, the EAS device can periodically interrogate the associated RFID label to insure that the two are still in proximity to each other. Embodiments of the EAS device that have a motion detecting chip, or element, would become active when movement is detected and interrogate the associated RFID label at that time as well. This occasional interrogation of the RFID label after the initial installation of the EAS device serves to monitor for theft by methods such as cutting the box to remove the product in the interior, etc. Movement also allows communication with the inventory system and also local information device, not just EAS.

Once an EAS device is assembled to an object and armed, unauthorized removal of the device is detected by the onboard electronics which sense an alarm condition via changes in state of any conditions required to arm the EAS device, such as changes to state in switches or loss of communication with the RFID label as described above. In response to a detected alarm condition, the electronics can generate an alarm, including onboard audible alarms, or alarms communicated to the EAS system via infra red signals, radio frequency signals, or other communication methods.

Disarming of the EAS device may be accomplished by authorized personnel. An authorized person having access to other elements of the EAS system such as a hand held communication device or a base station having communication capabilities may disarm the device. Depending on the embodiment of the EAS device, the communication may be accomplished via wireless communication or via contacts on the EAS device. In the former case, the wireless communication may be optical or radio frequency communication.

Some embodiments will add another element of security with passcode capabilities in the respective electronics. The EAS device electronics of these embodiments are capable of storing a passcode which is known to the communication elements of the EAS system and which can be used to confirm to the EAS device that the disarming signal is authorized. A further element of security can be added by using clock based algorithms to change the passcode synchronously. In those embodiments, the EAS system and the EAS device both have clock generators and are programmed with the same algorithm and both are programmed with the same initial passcode. As time passes, the algorithm alters the passcode at preset intervals as regulated by the clock generators. This changing passcode further complicates unauthorized attempts to disarm the EAS device. If an EAS device is detached without being disarmed with the appropriate passcode, the EAS device will detect an alarm condition and generate an alarm. In some system embodiments, the broader EAS system can reprogram the passcode of an EAS device. This allows an EAS device to be inserted into a time based algorithm system, or allows an EAS device to have a passcode reassigned as it is being armed, etc.

For embodiments of the EAS device where the electronics housing and the mount connect to each other, a blocking component or mechanism may be employed to physically prevent the release of a latch and the detaching of the housing portion from the mount portion. In one embodiment, a biased blocking member moves into a blocking position when the latch engages between the housing portion and the mount portion. The biased blocking member has a magnetically attractable element associated with it, and when a magnet is applied to the EAS device, the biased blocking member moves to a position where it no longer blocks the release of the latch. If a magnet is used to detach an EAS device without authorization and the EAS device is still armed, the electronics detect an alarm condition and generate an alarm. In some embodiments a magnet may be built into a communication device so that the EAS device may be disarmed and its latch released for detachment using the same device.

### BRIEF DESCRIPTION OF DRAWINGS

Additional utility and features of the invention will become more fully apparent to those skilled in the art by reference to the following drawings, which illustrate some of the primary features of preferred embodiments.

FIG. 1 shows an embodiment of an EAS device of the present invention affixed to a box and an RFID label within the box.

FIG. 2 shows an embodiment of the present invention with its top portion removed.

FIG. 3 shows an embodiment of the EAS device of the current invention being communicated with using a remote device.

FIG. 4 shows the bottom of the mount portion of an embodiment of an EAS device such as shown in FIG. 1 or FIG. 2.

FIG. 5 shows the top of an embodiment of the mount for the EAS device.

FIG. 6 shows the hinging hooks of a mount of an embodiment of the EAS device engaged in receptacles in the top housing portion of an embodiment an EAS device in the process of assembly or disassembly of an EAS device.

FIG. 7 is a sectioned view of the housing portion and mount portion of an embodiment of an EAS device latched in assembly and showing a latch and blocking component.

FIG. 8 is a sectioned view of the housing portion and base portion of the embodiment of an EAS device of FIG. 7 having a magnet applied to shift the blocking component and allow the unlatching of the two portions.

FIG. 9 is an exploded section view of an embodiment of an EAS device housing portion showing electronics and other internal elements.

FIG. 10 shows a detacher that may be used with embodiments of the EAS device of the present invention to activate, deactivate, and detach the various embodiments.

FIG. 11 shows the detacher of FIG. 10 in a retail location along with a base station.

FIG. 12 shows an embodiment of the present EAS device employing conduction elements wrapping around the object to be protected.

FIG. 13 shows the embodiment of the EAS device of FIG. 12 with its housing and mount separated.

FIG. 14 is a perspective view of an embodiment of the EAS device assembled by sliding motion.

FIG. 15 is a perspective view of another embodiment of the EAS device assembled by sliding motion.

FIG. 16-FIG. 23 show another embodiment of the EAS device being applied and removed from an object.

FIG. 24 and FIG. 25 show sample embodiments of RFID labels.

FIG. 26 is an elevated perspective view of an embodiment of an interchangeable mount for an EAS device.

FIG. 27 is an elevated perspective view of an embodiment of an interchangeable mount for an EAS device, the embodiment of FIG. 27 being different from the embodiment of FIG. 26.

FIG. 28 is a top view of several different embodiments of interchangeable mounts for an EAS device.

FIG. 29 is a bottom view of several different embodiment of interchangeable mounts for an EAS device.

FIGS. 30-33 are end views of several different embodiments of interchangeable mounts for an EAS device, the several embodiments having differently contoured bottom surfaces.

FIG. 34 is an elevated perspective view of the bottom surface of an embodiment of an interchangeable mount for an EAS device, the bottom surface being contoured to fit an object to be protected.

FIG. 35 is an elevated perspective view of an embodiment of an interchangeable mount adhered to an object, the bottom surface of the mount being contoured to fit the surface of that object.

### DETAILED DESCRIPTION OF EMBODIMENTS OF THE INVENTION

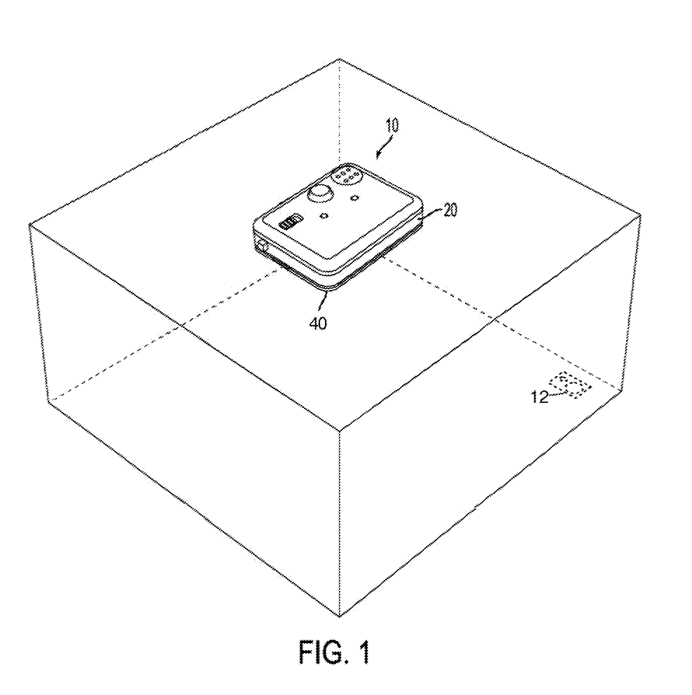

FIG. 1 shows an embodiment of an EAS device 10 of the present invention affixed to a box and an RFID label 12 within the box. EAS device 10 has a housing portion 20 and a mount portion 40. In the embodiment shown in FIG. 1, mount portion 40 attaches to an object, such as a box, that is to be protected, and housing portion 20 attaches to mount portion 40 in order to be attached to the object. Electronics within housing 20 interrogate RFID label 12 and store the information received from RFID label 12. EAS device 10 can then act as an RFID relay and communicate this information to a broader system. Housing portion 20 has its own onboard power source and can therefore generate a stronger signal to communicate over a greater distance than a passive RFID label.

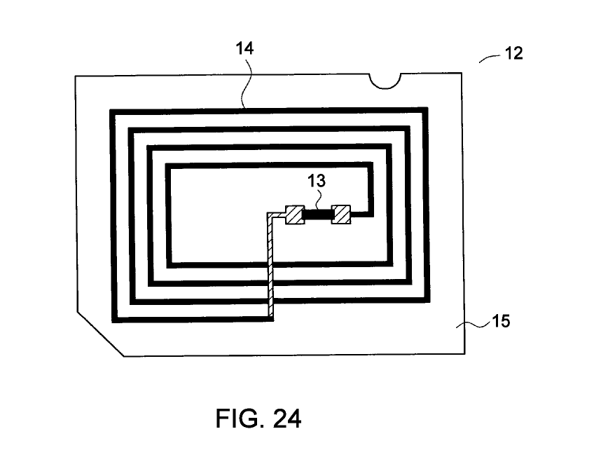

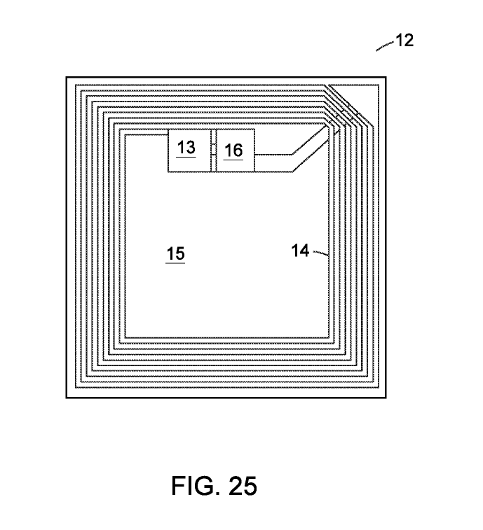

FIG. 24 and FIG. 25 show sample embodiments of RFID label 12 which is known in the art. Typically, RFID label 12 has IC chip 13 and antenna 14 mounted on substrate 15. Some RFID labels 12 may also have a capacitor 16 to improve some aspects of the performance of RFID label 12. IC chip 13 has memory which is accessible by external devices via radio frequency communication through antenna 14.

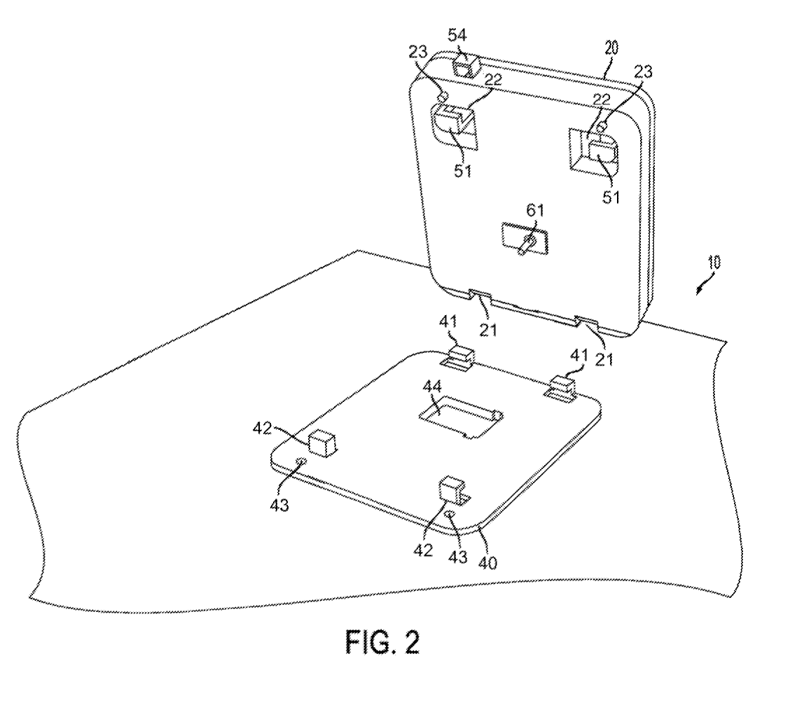

Referring now to FIG. 2, EAS device, or RFID relay, 10 is shown with housing 20 removed from mount portion 40 which is in place on an object to be monitored, such as a box containing a product. Housing portion 20 and mount 40 each have complimentary attaching components for assembling housing 20 and mount 40 together. In FIG. 2, hinging hooks 41 are visible along the far edge of mount portion 40. Not as visible in FIG. 2, are receptacles 21 along the lower side and bottom edge of housing 20. Receptacles 21 of housing 20 are located to match and receive hinging hooks 41 of mount 40. Looking forward in the figures, FIG. 6 shows housing 20 partially assembled to mount 40 with hinging hooks 41 engaged in receptacles 21. In the fore area of mount 40 in FIG. 2, latch receivers 42 extend upwardly from the top surface of mount 40. Latch receivers 42 are generally formed to engage with a latch element and therefore have a somewhat hooked or concaved shape. This aspect of latch receivers 42 may be more readily observed in FIG. 6. In close proximity to latch receivers 42 in FIG. 2 are alignment apertures 43. In FIG. 2, on the bottom surface of housing 20 and above latch receivers 42 and alignment apertures 43, are located latch pockets 22 and alignment pins 23. Latch pockets 22 are located and sized to receive latch receivers 42 when housing 20 and mount 40 are assembled together, while alignment pins 23 are located and sized to fit into alignment apertures 43 in mount 40. Visible in latch pockets 22 are latch hooks 51. In the embodiment shown in FIG. 2, latch hooks 51 can be moved to engage latch receivers 42 once housing 20 is assembled to mount 40. When housing 20 is assembled to mount 40, alignment pins 23 insert into alignment apertures 43 to provide positive location and stability until latch hooks 51 are engaged into latch receivers 42.

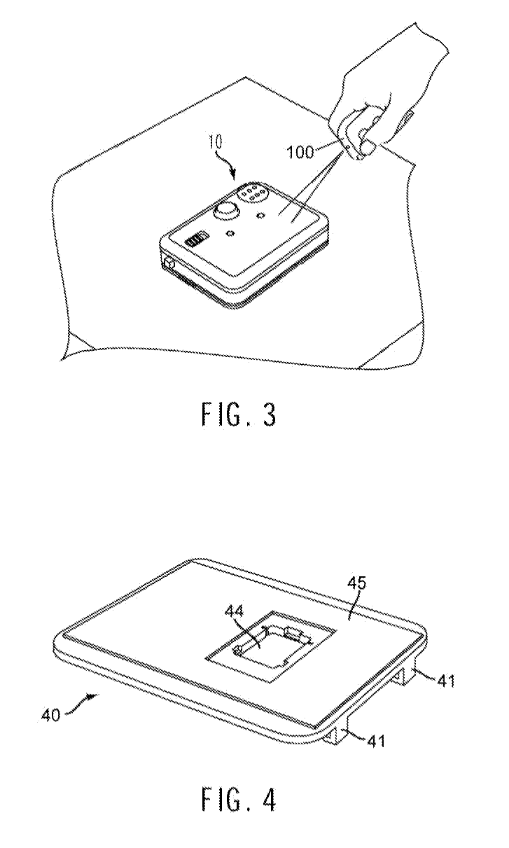

Installation switch 61 extends from the bottom surface of housing 20. Mount aperture 44 in mount 40 is located to match the location of Installation switch 61 when housing 20 is assembled to mount 40. The alignment of mount aperture 44 with Installation switch 61 results in Installation switch 61 not being affected by the assembly of housing 20 to mount 40 unless the bottom off mount 40 is contacting an object. When the bottom of mount 40 is contacting an object, as when EAS device 10 is assembled to an object, shown in FIG. 1 and FIG. 3, Installation switch 61 has its state changed and the electronics can interpret this as an arming signal, i.e. EAS device 10 is installed and communication from an exterior device can initiate secure monitoring of the object. EAS device 10 can generate a system alarm by communicating its change of status with the system via radio frequency communication from the electronics in housing 20 or other forms of communication.

FIG. 3 shows a hand held remote 100 activating EAS device 10. The assembly of EAS device 10 to an object establishes the conditions for activating, or arming, EAS device 10. Hand held remote 100 may communicate with EAS device 10 with any of several known methods. These methods may include infrared communication and radio frequency communication as well as other known communication methods. Handheld remote 100 may also be used to deactivate, or disarm EAS device 10 to allow EAS device 10 to be removed without causing an alarm. The electronics of some embodiments of EAS device 10 may have passcode protection. These embodiments are capable of storing a passcode which is required to be matched by handheld remote 100 for the communication from handheld remote 100 to be authorized. For further protection, the electronics of some embodiments of EAS device 10 may include a clock generator and the electronics may have machine readable instructions with an algorithm to change the passcode at preprogrammed time intervals. The broader EAS system, including handheld remote 100, also has at least one clock generator and is capable of updating the passcode at the preset intervals to update the systems record of the passcode. This keeps the passcode between EAS device 10 and the rest of the EAS system synchronized.

FIG. 4 shows the bottom surface of mount portion 40. Bottom surface of mount portion 40 has an adhesive element 45. Adhesive element 45 facilitates the assembly of EAS device 10 on an item to be protected and is constructed, or applied in such a manner as to not cover mount aperture 44. Mount portion 40 is placed on an item to be protected with adhesive elements 45 on the bottom surface of mount portion 40 contacting the object to place the top surface of mount portion 40 in an exposed position. Once mount portion 40 is satisfactorily installed on an object desired to be protected, as shown in FIG. 2, housing portion 20 may be installed on mount portion 40. Adhesive elements 45 on bottom surface of mount portion 40 may be comprised of a pressure sensitive adhesive pad, a pre-applied contact adhesive, or may even be an adhesive applied at the time of use, such as a spray, paste, pressure sensitive adhesive pad, or other applicable adhesive, as long as adhesive element 45 does not cover mount aperture 44 and negate the operation of Installation switch 61.

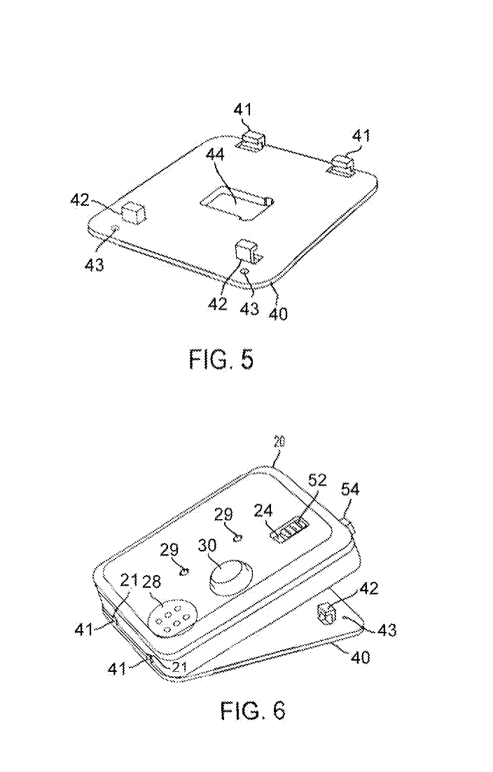

FIG. 5 shows the top surface of mount 40. Many of the elements visible in FIG. 5, such as the attaching components, have already been described with respect to FIG. 2. Along one edge of mount 40 are hinging hooks 41. Latch receivers 42 extend upwardly from the top surface of mount 40 in the opposite half of mount 40 from hinging hooks 40. Alignment apertures 43 are located in proximity to latch receivers 42. Mount aperture 44 is generally centrally located in mount 40 but somewhat offset from exact center in the embodiment shown in FIG. 5.

FIG. 6 is a perspective view of hinging hooks 41 of mount 40 engaging receptacles 21 of housing 20. In FIG. 6, housing 20 is angled upward from mount 40 along the edge of mount 40 where hinging hooks 41 are located. Hinging hooks 41 of mount 40 are engaged in receptacles 21 forming an initial, rotational connection between mount 40 and housing 20. To complete assembly of housing 20 to mount 40, housing 20 is rotated down onto mount 40 where a latch may engage latch receivers 42, shown toward the further end of the top surface of mount 40. Latch receivers 42 are shaped to facilitate engagement by a latch.

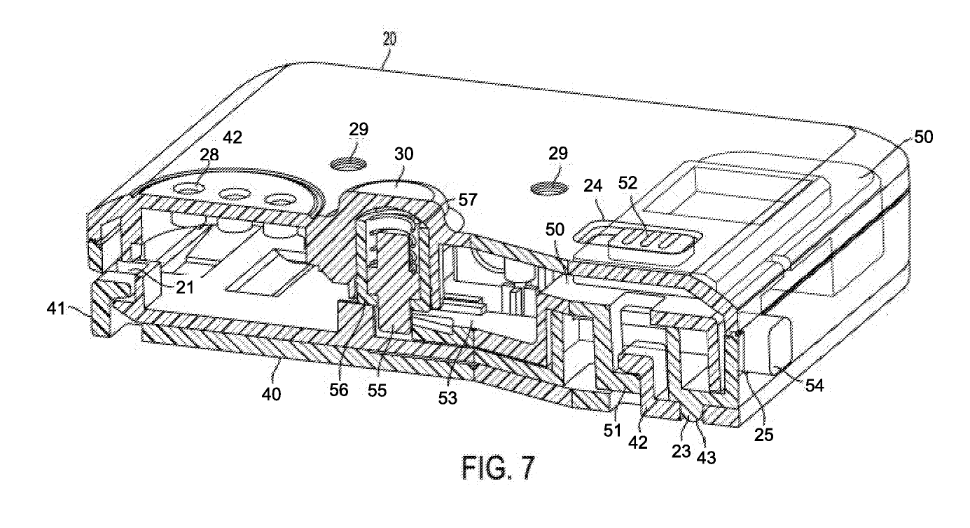

FIG. 7 is a sectioned view of housing portion 20 and mount portion 40 of an embodiment of an EAS device 10 latched in assembly and showing a latch 50 holding housing 20 and mount 40 together. A blocking component, which in the embodiment of FIG. 7 is a blocking pin 55, prevents disengagement of latch 50. Several elements previously described are visible in the section view of FIG. 7. At the far left, hinging hooks 41 of mount 40 are engaged in receptacles 21 of housing 20. Toward the right end of the section, a latch receiver 42 is inserted up into a latch pocket 22 where a latch hook 51 engages latch receiver 42. Further to the right, an alignment pin 23 in housing 20 engages an alignment aperture 43 in mount 40.

In the embodiment shown in FIG. 7, latch 50 is a manually operated sliding latch and once it is slid to engage latch hooks 51 into latch receivers 42, blocking pin 55 moves into place to prevent its return to a non-engaged position. Blocking pin 55 is contained within cup 56 and spring 57 biases blocking pin 55 toward a blocking position. In the embodiment of FIG. 7, engagement slide 52 extends upward from the body of latch 50 and is exposed through slide aperture 24 in housing 20, which gives a user access to engagement slide 52 to move latch 50 to an engaged state. When latch 50 is moved to an engaged state, guide 53 on latch 50 is moved out from beneath blocking pin 55 allowing blocking pin 55 to shift position to perform a blocking function. When latch 50 is moved to an engaged position, release button 54 on latch 50 is extended out through button aperture 25 in the side of housing 20.

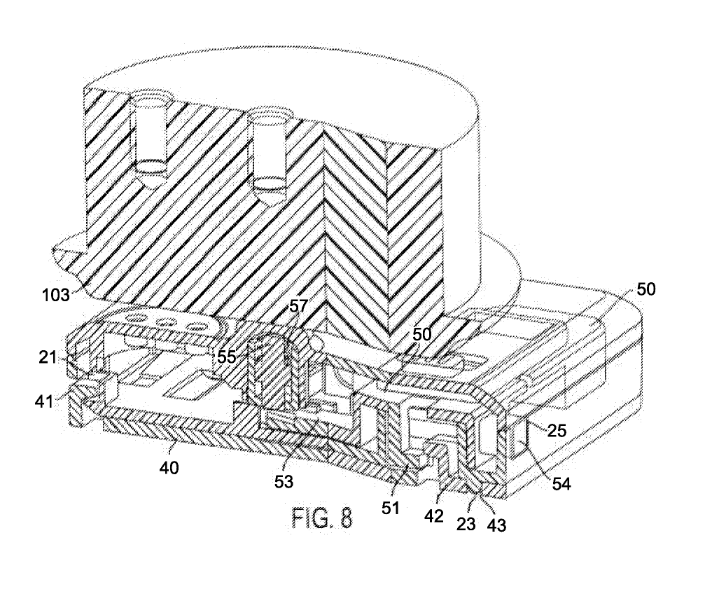

FIG. 8 is a sectioned view of housing portion 20 and mount portion 40 of the embodiment of an EAS device 10 shown in FIG. 7 having a magnet 103 applied to housing 20 to shift blocking pin 55 to a non-blocking position. Blocking pin 55 has some magnetically attractable element associated with it which allows magnet 103 to act upon it to overcome spring 57 and shift blocking pin 55 to the non-blocking position. Once blocking pin 55 is shifted to a non-blocking position, release button 54 may be depressed to shift latch 50 to the left in FIG. 8, moving guide 53 on latch 50 under blocking pin 55 to maintain blocking pin 55 in a non-blocking position. As may be seen in FIG. 8, when release button 54 is depressed and latch 50 is moved to the left, latch hook 51 on latch 50 disengages from latch receiver 42. The disengagement of latch hook 51 from latch receiver 42, allows housing 20 to rotate upward about the interface of hinging hook 41 on mount 40 with receptacle 21 on housing 20 seen at the left in FIG. 8. Returning to FIG. 6, housing 20 may be seen engaged with mount 40 and rotating about the engagement between hinging hooks 41 and receptacles 21. In the embodiment shown in FIG. 8, the top of release button 54 becomes flush with the side of housing 20 when latch 50 is moved to an unengaged position, and engagement slide 52 moves to the left in slide aperture 24.

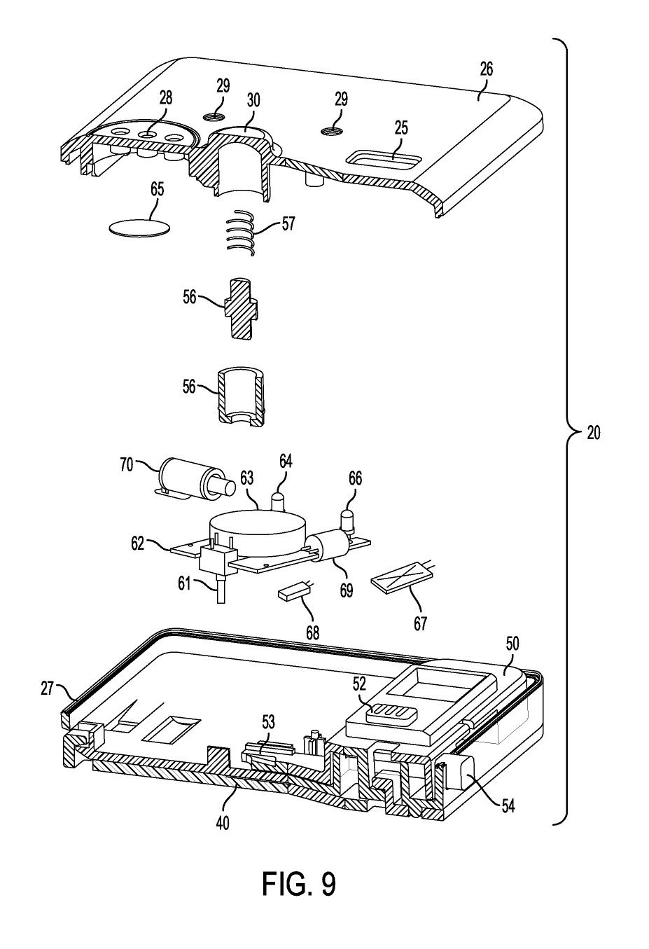

FIG. 9 is an exploded section view of an embodiment of an EAS device 10 housing portion 20 showing electronics and other internal elements. In the embodiment shown in FIG. 9, housing 20 is assembled from two halves, a top half 26 and a bottom half 27 which enclose and support several elements. Latch 50 is seated in bottom half 27, while blocking pin 55, cup 56, and spring 57 are disassembled vertically above bottom half 27. Receptacles 21, latch pockets 22, alignment pins 23, and button aperture 25 are visible on bottom half 27.

FIG. 9 shows the electronics 60 enclosed in housing 20. Circuit board 62 provides an internal mount for several of the electronic components. In the embodiment shown in FIG. 9, Installation switch 61, previously described with respect to FIG. 2, is mounted to circuit board 62. Other elements that may be housed within EAS device 10 include microprocessor 63, infrared communication port 64, audible alarm generator 65, light emitting diode 66, radio frequency communication elements 67, motion detector 68, and battery 69, many of which may mount directly to circuit board 62. Additionally, housing 20 may also carry a core and coil electronic article surveillance element 70.

Circuit board 62 and microprocessor 63 are capable of storing machine readable instructions and are programmable to monitor the status of EAS device 10 and to communicate with remote programmers and other elements of an EAS system. Circuit board 62 and microprocessor 63 may be reprogrammed via communication with hand held remotes, such as handheld remote 100 in FIG. 3, or other elements of an EAS system when communicating with these devices. In the embodiment shown in FIG. 9, circuit board 62 and microprocessor 63 can communicate via infrared communication port 64 and also receive programming instructions. EAS device 10 interrogates RFID label 12 with radio frequency communication elements 67, radio frequency elements 67 may also be used to communicate with other components of the EAS system. Audible alarm generator 65 is capable of generating an audible alarm when EAS device 10 is tampered with, for example, in an attempted forced separation of housing 20 and mount 40, or when EAS device 10 does not receive a response from an associated RFID label 12 when an interrogation signal is sent. Audible alarm generator 65 may also be used to indicate the status of EAS device 10 as it is assembled, for example, when installation switch 61 has been actuated through assembly of housing portion 20 and mount portion 40 onto an object and communication has been established with an RFID label. Similarly, LED 66 can be used to provide visual cues for the status of EAS device 10. Battery 69 generally provides power for the electronic components of EAS device 10.

EAS element 70 is a passive element compatible with prior art EAS systems. These EAS systems generate what is called an interrogation field at a given frequency. These interrogation fields will build up a small amount of stored energy on passive EAS elements brought into the zone. When the interrogation field is turned off and the EAS system listens for a response, the passive EAS elements dissipate their energy and generate a signal at a designed frequency. The EAS system is capable of detecting the signal as an indication of the unauthorized presence of the passive elements and can generate an alarm based on the signal. The EAS elements 70 contained within the embodiment of EAS device 10 in FIG. 9 is compatible with prior art and legacy systems providing an addition security mechanism. In addition to the prior art system detection of the passive EAS element 70, in some embodiments circuit board 62 and microprocessor 63 can monitor the status of passive element 70 and issue an alarm as well. If microprocessor 63 or circuit board 62 detects energy storage and dissipation activity in the coil, then audible alarm generator 65 may be instructed to generate an alarm or the communication capabilities of the electronics 60 may be employed to broadcast a signal to respective receivers in the broader EAS system to generate an alarm.

Top half 26 of housing 20 provides the necessary apertures for the electronic components of EAS device 10 to communicate with its environment. Sound apertures 28 allow audible alarms generated by audible alarm generator 65 easier escape to the surroundings, while light apertures 29 are generally aligned with infrared communication port 64 and LED 66 to allow direct line of sight communication via those elements. Light apertures 29 may or may not have some type of translucent covering. Additionally, top half 26 of housing 20 has a dome 30 where blocking pin 55 is housed which provides a visual cue where to apply magnet 103 to allow disengagement of latch 50.

Alternatively, installation switch 61 on the bottom of housing 20 may be used to monitor the status of EAS device 10. When housing 20 is assembled to mount 40, Installation switch 61 is actuated, informing circuit board 62 and microprocessor 63 of the status of the device. Unauthorized separation of housing 20 from mount 40 changes the status of Installation switch 61 and the electronics 60 of housing 20 will detect this and respond as programmed.

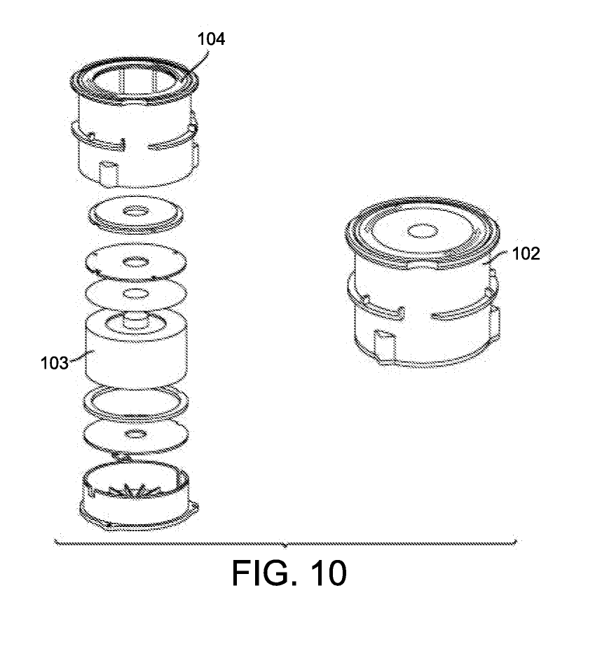

FIG. 10 shows a hand held detacher 102 that may be used with embodiments of the EAS device 10 of the present invention to activate, deactivate, and detach the various embodiments of EAS device 10. In FIG. 10, detacher 102 is shown both assembled and exploded into components. Detacher 102 includes magnet 103 as well as some elements of handheld remote 100 described above with respect to FIG. 3. Detacher 102 also has an infrared communication port 104 or other communication elements. Hand held detacher 102 can communicate with EAS device 10 to disarm it while magnet 103 of detacher 102 is placed on EAS device 10 to actuate a release of a latching mechanism in housing 20 and release housing 20 from mount 40. Alternatively to infrared communication, radio frequency communication may be used. Once the electronics 60 of housing 20 are disarmed, housing 20 may be lifted from mount 40 which will change the status of Installation switch 61 without electronics 60 in housing 20 generating an alarm. As described previously, some embodiments of detacher 102 and housing 20 will exchange an encrypted passcode to offer a further level of security. Additionally, some embodiments of EAS device 10 will have a clock generator and the electronics 60 will have machine readable instructions with an algorithm to alter the passcode at predetermined time intervals. The EAS system will also have at least one clock generator and have machine readable instructions with the same algorithm to continuously update the passcode synchronously with EAS device 10. Detacher 102 may be powered by a cable 105 connected to an element within the EAS system, or detacher 102 may simply be tethered to another object to prevent it from being mislaid or stolen. In some embodiments cable 105 will provide communication capabilities between a base station 106 and EAS device 10 via detacher 102.

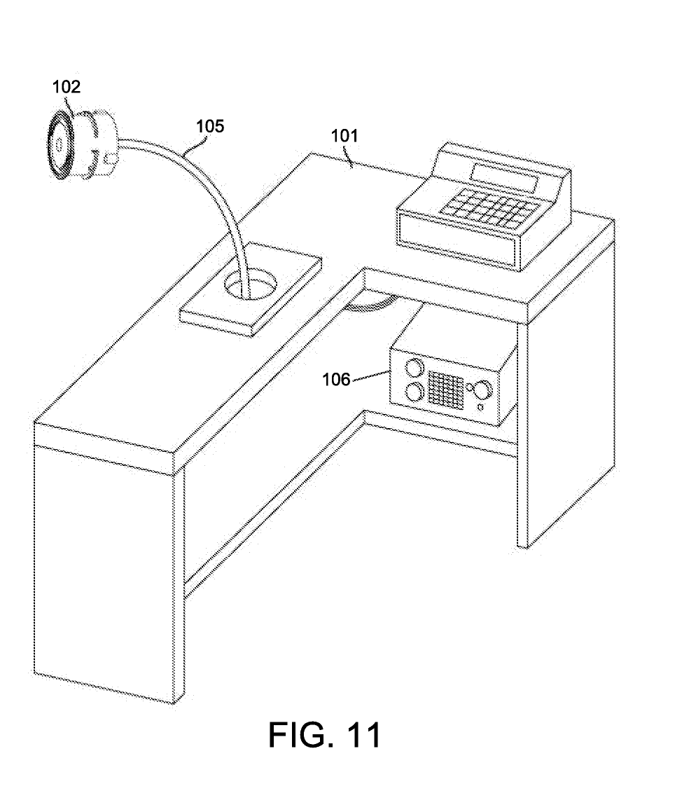

FIG. 11 shows detacher 102 removed from its mount in a retail counter 101. In situations where the object being protected by EAS device 10 is too large to be placed on a counter, detacher 102 may be extended from its typical position to be applied to the object and detach EAS device 10. Smaller objects can be applied to detacher 102 as it is mounted in the retail counter 101.

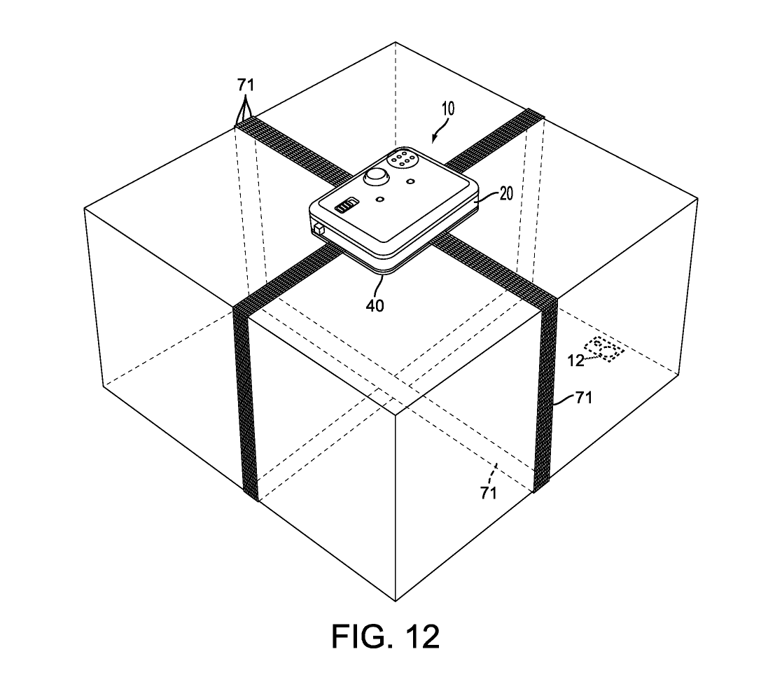

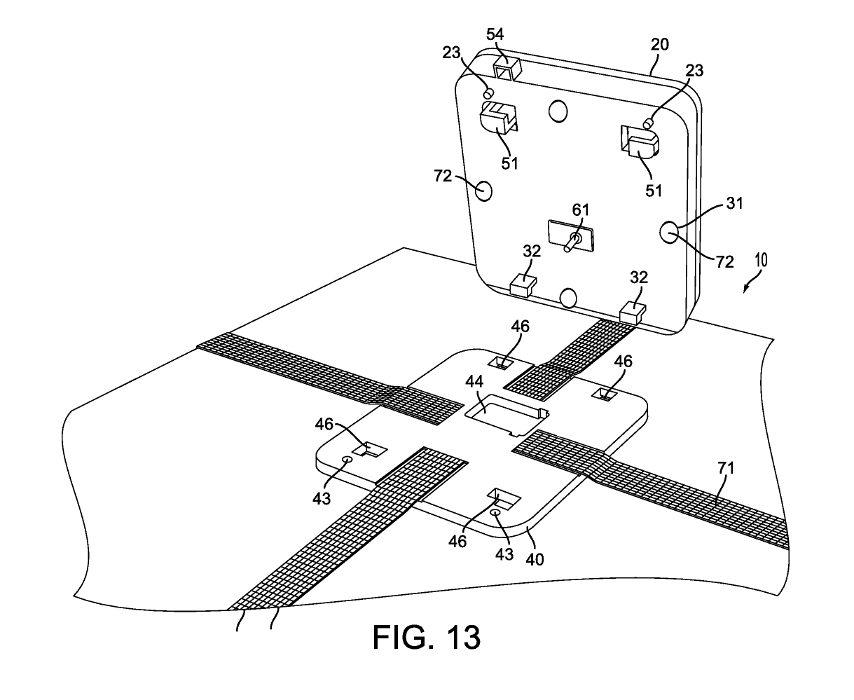

FIG. 12 shows an embodiment of EAS device 10 employing conductive elements 71 wrapping around the object to be protected. In this embodiment, conductive elements 71 wrap around the object to be protected and terminate between housing 20 and mount 40. FIG. 13 shows the embodiment of EAS device 10 of FIG. 12 with housing 20 and mount 40 separated. In FIG. 13, contacts 72 through apertures in the bottom of housing 20 are positioned to make contact with the conductive elements 71. Contacts 72 are in electrical continuity with electronics within housing 20 which monitor the conductive elements 71 for integrity to monitor for tampering. As with other embodiments of EAS device 10, the electronics within housing 20 interrogate RFID label 12 within the box (FIG. 12) and retransmit the received information to the broader EAS system. The completion of circuits through the conductive elements 71 may be an additional requirement for arming of this embodiment of EAS device 10

In the embodiment of FIG. 13, the manner in which housing 20 and mount 40 assemble is similar to previous embodiments. However, as may be seen in FIG. 13, mount 40 presents a smooth top surface and does not present the projections of the previous mount. Rather, mount 40 has several apertures mounting apertures 46, or pockets, which are matched by projections on the bottom of housing 20. One set of projections 32 is fixed on housing 20, while another moving set of projections, latch hooks 51, moves on a latch located within housing 20. Once housing 20 is placed on mount 40, the latch is moved and latch hooks 51 move which causes all of the projections 51, 32 to engage the edge of their respective mounting apertures 46. A blocking mechanism in housing 20 prevents the release of the latch until EAS device 10 is disarmed.

Mount 40 may be attached to a box or other object with an adhesive element. Installation switch 61 on the bottom of housing 20 aligns with mount aperture 44 through mount 40. When installation switch's 61 state changes, this provides a signal to the electronics that EAS device 10 is assembled to an object. Also, a later change of state for the switch can indicate unauthorized removal of EAS device 10.

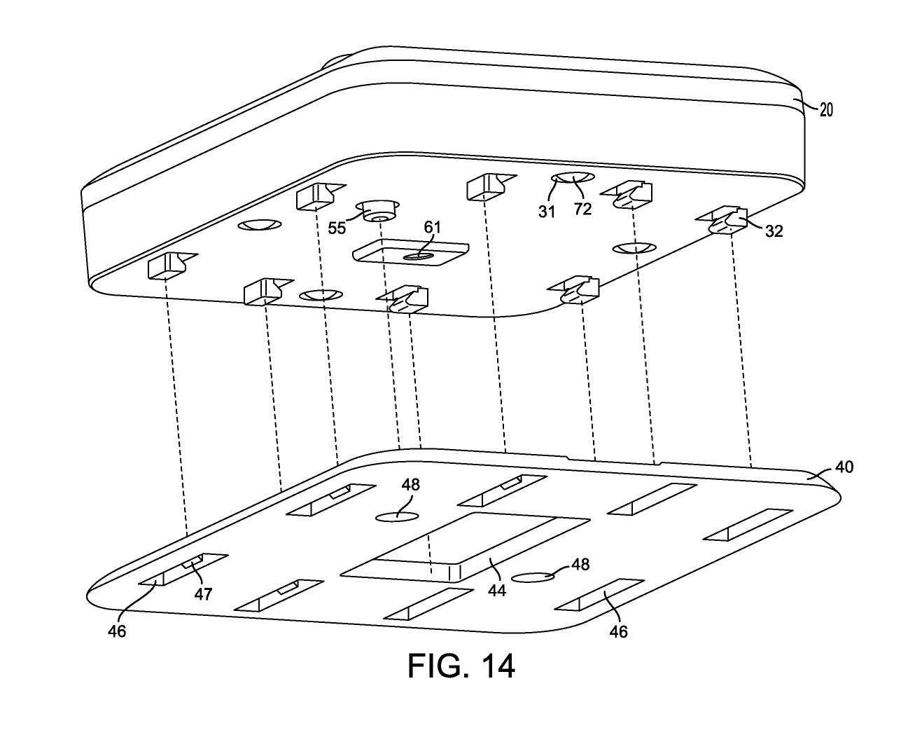

FIG. 14 is a perspective view of an embodiment of EAS device 10 assembled by sliding motion. Mount 40 has several mounting apertures 46 formed as slots through it with each slot having a tab 47 extending out into its open space. Fixed projects in the form of hooks 32 located on the bottom of housing 20 are positioned to match up with the slots. To assemble housing 20 to mount 40, housing 20 is placed on mount 40 with hooks 32 in the slots 46. Housing 20 is then slid and hooks 32 engage tabs 47 in slots 46 to maintain housing 20 on mount 40. Also, as housing 20 is slid, spring loaded pin 55 in housing 40 aligns with locking aperture 48 in mount 40 and spring loaded pin 55 extends into locking aperture 48. Spring loaded pin 55 prevents housing 20 from sliding with respect to mount 40 until the pin is withdrawn. In some embodiments, this is done by application of a magnet to the top of housing 40.

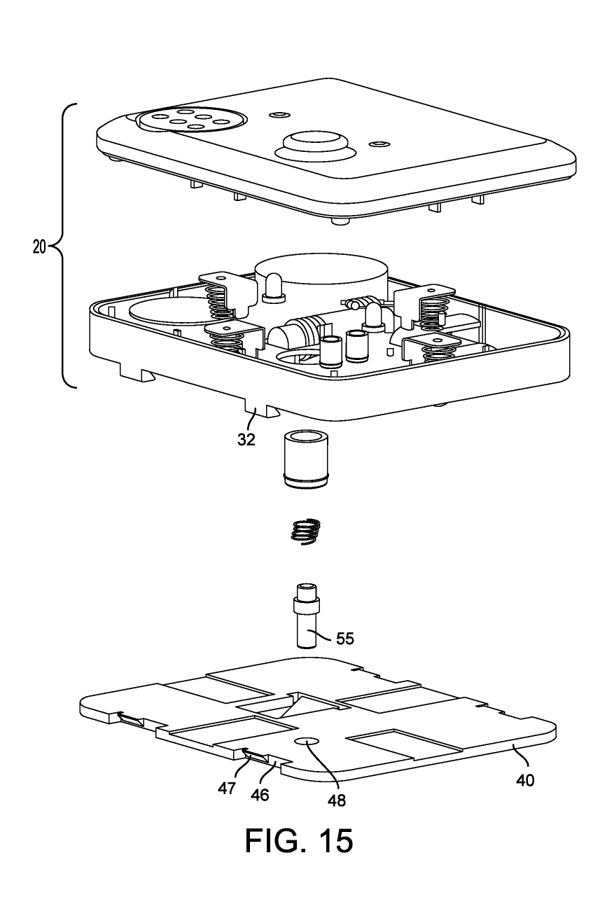

FIG. 15 is a perspective view of another embodiment of the EAS device assembled by sliding motion. FIG. 15 also shows the circuit board, electronics, and contacts within housing 20 as well as spring loaded pin 55. In the embodiment of FIG. 15 housing 20 is coupled to mount 40 along opposing edges of mount 40. Mount 40 has notches, or apertures 46, along opposing edges with tabs 47 extending into the space of the notches. Hooks 32 at the edges of the bottom of housing 20 are positioned to match notches 46 and housing 20 is assembled to base 40 as in the embodiment of FIG. 14. Again, spring loaded pin 55 keeps housing 20 from sliding with respect to mount 40 by inserting into locking aperture 48.

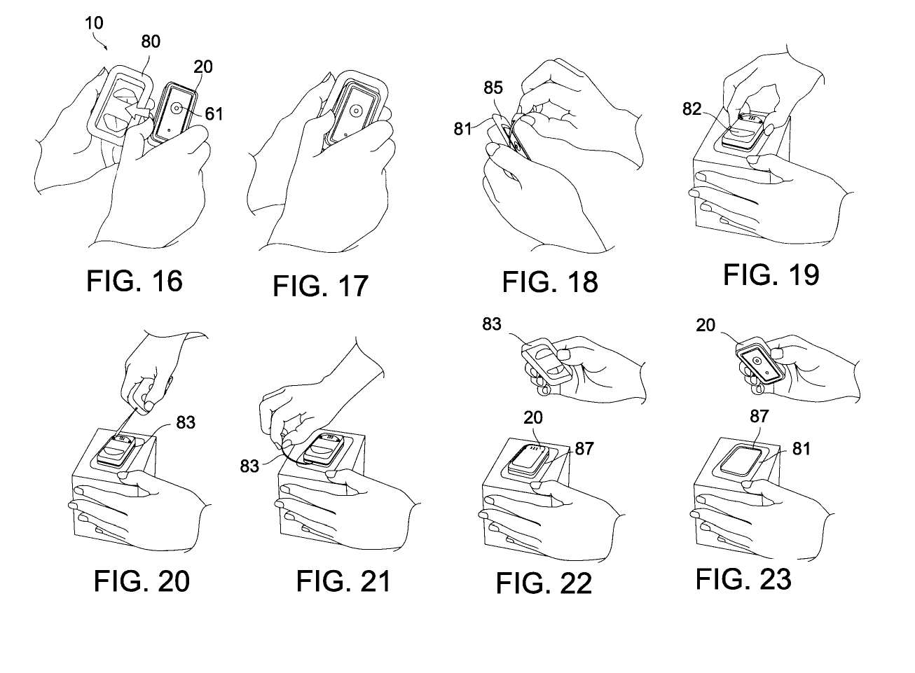

FIG. 16-FIG. 23 show another embodiment of the EAS device 10 being mounted to an object and removed from the object. In FIG. 16, mount 80 is cup shaped and sized to at least partially enclose electronics housing 20. In the embodiment of FIGS. 16 through 23, mount 80 has an open side which allows insertion of electronics housing 20 while the cup shape of mount 80 otherwise fully encloses housing 20 when EAS device 10 is assembled to an object. An external flange 81 around the open side of mount 80 has an adhesive element 85 which allows mount 80 to be affixed to an object, maintaining housing 20 on the object as well.

Installation switch 61 on the bottom of housing 20 provides an initial signal that housing 20 and mount 80 are in place on an object. Electronics within housing 20 produce an interrogation signal to establish an association with an RFID label located within the box. Completion of this association provides an additional indication that EAS device 10 is ready to be armed by a user. EAS device 10 can be armed by an external device. For embodiments employing optical communication, mount 80 has clear windows 82 in it to allow signals to pass between housing 20 and external devices, such as shown in FIG. 20. The electronics of the embodiment of FIGS. 16-23 have all the capabilities of previous embodiments.

In FIGS. 16 and 17, a user is placing a housing 20 into a mount 80. Installation switch 61 on the bottom of housing 20 can be seen in FIGS. 16 and 17. In FIG. 18, a cover is being pealed off to expose an adhesive element 85 on the bottom of flange 81 on mount 80. In FIG. 19, the apparatus is placed on an item to be protected and is held in place by adhesive element 85. In that position, installation switch 61 is depressed, sending a signal to the electronics in housing 20. EAS device 10 is now installed. Window 82 in mount 80 allows infrared (optical) communication between EAS device 10 and an external device. Some embodiments may employ radio frequency communication.

FIG. 20 shows EAS device 10 being armed or disarmed by an external device, depending on whether EAS device 10 is being installed or removed. As stated above, the communication may be optical communication or radio frequency communication. FIGS. 21 through 23 show the EAS device 10 being removed from the item to be protected. In FIG. 21, frangible band 83 is pulled from around the joint between upper portion 86 and lower portion 87 of mount 80. In FIG. 20, upper portion 86 is removed from lower portion 87, exposing housing 20. In FIG. 23, housing 20 is removed from the item. Once removed, housing 20 may be coupled with another mount 80 and reused. This allows the higher value component of the apparatus to be reused repeatedly, while providing ease of removal once the EAS device is disarmed. The use of an adhesive provides a simple method of attachment to many articles.

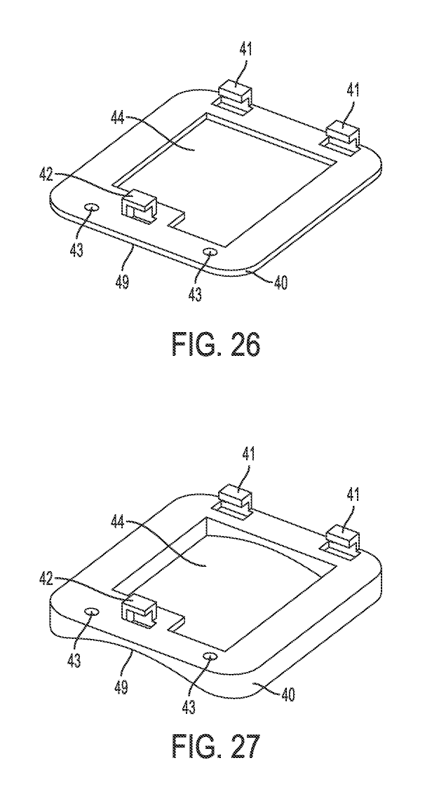

FIG. 26 is an elevated perspective view of an embodiment of an interchangeable mount 40 for an EAS device 10, and FIG. 27 is an elevated perspective view of another embodiment of an interchangeable mount 40 for an EAS device 10, the embodiment of mount 40 of FIG. 27 being different from the embodiment of FIG. 26. Similar to mount 40 of FIG. 5, mounts 40 of FIGS. 26 and 27 have hinging hooks 41 matching receptacles in an EAS housing. Mounts 40 of FIGS. 26 and 27 also have a central aperture 44, but the aperture in the embodiments of FIGS. 26 and 27 are larger. The embodiments of mounts 40 in FIGS. 26 and 27 also have latch receiver 42, but the embodiments of mounts 40 in FIGS. 26 and 27 only have one latch receiver 42, and it is oriented 180° from that of the latch receiver 42 of the embodiment in FIG. 5. Hinging hooks 41 and latch receiver 42 of the embodiments of mount 40 of FIGS. 26 and 27 cooperate with elements in an EAS device 10 to attach the EAS device 10 to the mount 40. Bottom surface 49 of mounts 40 adhere to an object to be protected and mounts 40 in turn maintain EAS devices 10 on objects to be protected.

As between interchangeable mounts 40 of FIGS. 26 and 27, a significant difference can be seen at bottom surface 49 of the embodiments. In FIG. 26, bottom surface 26 is planar, flat. In FIG. 27, bottom surface 49 is curved. Although mounts 40 are interchangeable in how that connect with an EAS device 10, their differently contoured bottom surfaces 49 allow the respective mounts 40 to securely adhere to differently contoured object to be protected. The embodiment of mount 40 in FIG. 27, with its curved bottom surface 49 can securely adhere to an object having a matching curved surface.

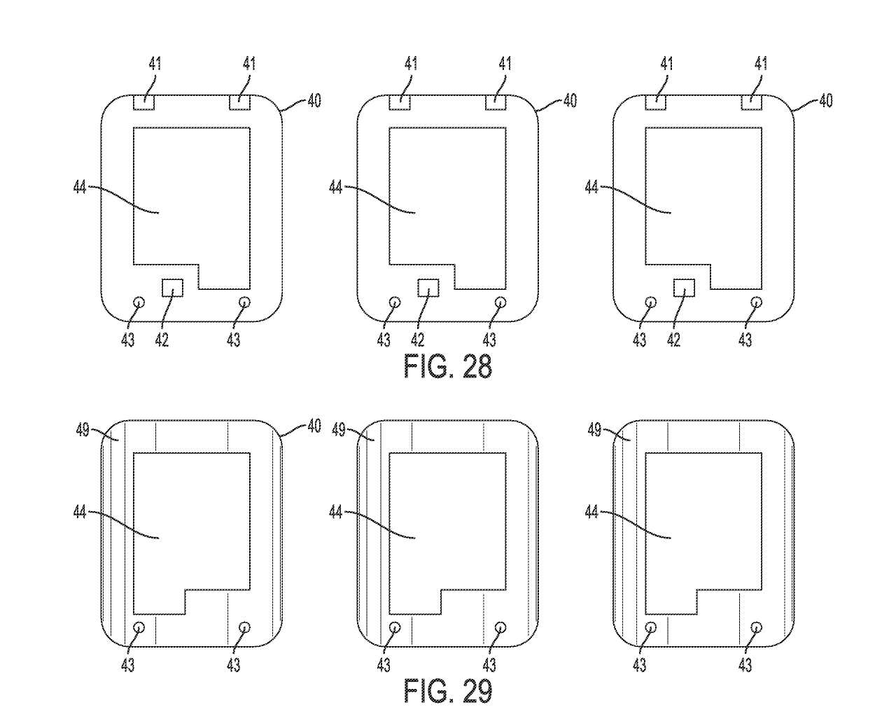

FIG. 28 is a top view of several different embodiments of interchangeable mounts 40 for an EAS device 10, and FIG. 29 is a bottom view of several different embodiments of interchangeable mounts for an EAS device 10. As may seen in FIGS. 28 and 29, across the several embodiments of mounts 40, hinging hooks 41 and latch receiver 42 are in the same relative positions, and base aperture 44 has the same shape to accommodate features on EAS device 10. In the way, mounts 40 are interchangeable with each other with respect to EAS device 10.

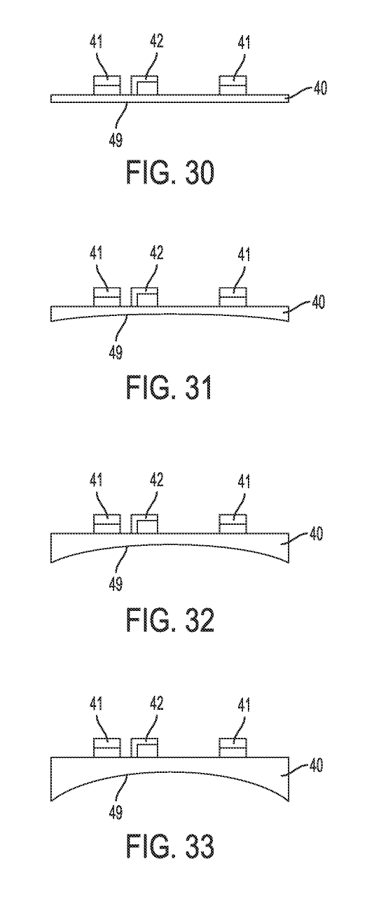

FIGS. 30-33 are end views of several different embodiments of interchangeable mounts 40 for an EAS device, the several embodiments having differently contoured bottom surfaces 49. In FIG. 30, bottom surface 49 is flat. In FIG. 30, bottom surface 49 has a slight curvature and this curvature increases in FIG. 32 and more so in FIG. 33. Although the curvatures of bottom surfaces 49 in FIGS. 31-33 are shown as circular, different embodiments of mount 40 can have bottom surfaces 49 of varying contours to match surfaces of respective items to be protected, while still connecting with an EAS device 10 at hinging hooks 41 and latch receiver 42.

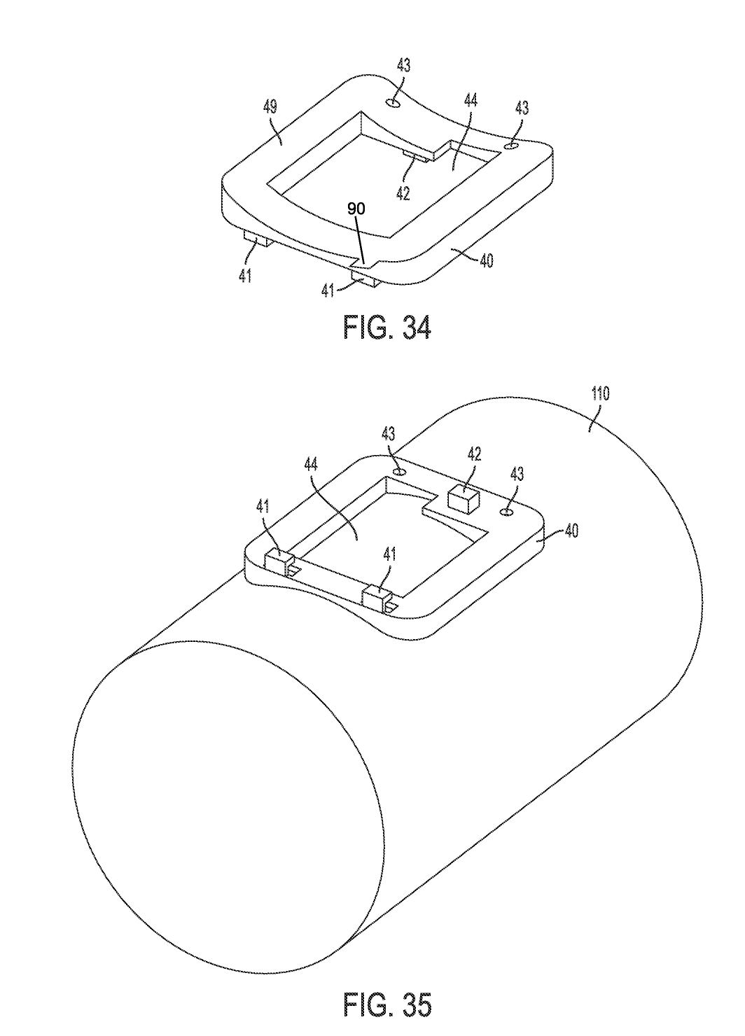

FIG. 34 is an elevated perspective view of bottom surface 49 of an embodiment of interchangeable mount 40 for an EAS device 10, bottom surface 49 being contoured to fit an object to be protected. In FIG. 34, peelable cover 90 covers an adhesive element such as adhesive element 45 in FIG. 4. To attach mount 40 to an object to be protected, peelable cover 90 is removed to expose the adhesive element on bottom surface 49 and bottom surface 49 of mount 40 is pressed onto a matching surface of an object to be protected. FIG. 35 is an elevated perspective view of an embodiment of an interchangeable mount 40 adhered to an object 110. The bottom surface 49 of mount 40 is contoured to fit the surface of object 110.

It is to be understood that the embodiments and claims are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

I claim:

1. An EAS device comprising:
an electronics housing and a mount for said electronics housing;
said electronics housing enclosing an electronics package and comprising a first coupling element;
said mount comprising a second coupling element complimentary to said first coupling element, said first and second coupling elements coupling to maintain said electronics housing on said mount;
said mount further comprising a contoured surface, said contoured surface shaped to fit the contoured surface of an object to be protected.

2. The EAS device of claim 1, further comprising:
an adhesive element on said contoured surface of said mount.

3. The EAS device of claim 1, wherein:
said electronics package comprises a microprocessor, radio frequency communication elements, and a power supply powering the other components of said electronics package.

4. The EAS device of claim 1, wherein:
said electronics package comprises a passive electronic article surveillance element.

5. The EAS device of claim 1, further comprising:
a set of multiple mounts interchangeable with respect to said housing, each mount within said set having differently contoured surfaces for mounting to different objects having different contours, allowing said housing to be mounted to differently contoured objects.

6. The EAS device of claim 1, wherein:
said first coupling element of said housing comprises a latch, said latch being moveable to engage said second coupling element of said mount to maintain said housing on said mount.

7. The EAS device of claim 6, further comprising:
a blocking component within said housing, said blocking component biased to shift position to a blocking position to block the return of said latch when said latch is moved to engage said second coupling element on said mount.

8. The EAS device of claim 7, wherein:
said blocking component is magnetically attractable to move it from said blocking position to allow the disengagement of said latch from said second coupling component on said mount.

9. An EAS device comprising:
an electronics housing and a set of interchangeable mounts for said electronics housing;
said electronics housing enclosing an electronics package and comprising a first coupling element;
each said mount comprising a second coupling element complimentary to said first coupling element, said first and second coupling elements coupling to maintain said electronics housing on a mount;
each said mount further comprising a contoured surface and each said contoured surface uniquely contoured within said set of mounts, said contoured surfaces shaped to fit differently contoured surfaces of object to be protected
said set of mounts allowing said housing to be attached to differently contoured objects.

9. The EAS device of claim 8, further comprising:
an adhesive element on each said contoured surface of said mounts.

10. The EAS device of claim 8, wherein:
said electronics package comprises a microprocessor, radio frequency communication elements, and a power supply powering the other components of said electronics package.

11. The EAS device of claim 8, wherein:
said electronics package comprises a passive electronic article surveillance element.

12. The EAS device of claim 8, wherein:
said first coupling element of said housing comprises a latch, said latch being moveable to engage said second coupling element of said mounts to maintain said housing on a mount.

13. The EAS device of claim 12, further comprising:
a blocking component within said housing, said blocking component biased to shift position to a blocking position to block the return of said latch when said latch is moved to engage the second coupling element on a mount.

14. The EAS device of claim 13, wherein:
said blocking component is magnetically attractable to move it from said blocking position to allow the disengagement of said latch from the second coupling component on a mount.
